(19) United States
(12) Patent Application Publication
(10) Pub. No.: US 2008/0148335 A1
(43) Pub. Date: Jun. 19, 2008

(54) Expansion of television functionality

(76) Inventors: Thomas Patrick Dawson, Escondido, CA (US); Robert L. Hardacker, Escondido, CA (US)

Correspondence Address: MILLER PATENT SERVICES, 2500 DOCKERY LANE, RALEIGH, NC, 27606, US

(21) Appl. No.: 11/639,504

(22) Filed: Dec. 15, 2006

(51) Int. Cl. H04N 7/173

(52) U.S. Cl. 725/132

(57) ABSTRACT

A method of expansion of a television receiver's functionality consistent with certain embodiments involves connecting an accessory device to the television receiver, wherein the accessory device adds functionality to the television receiver; sending a menu legend and an associated function command to the television receiver from the accessory device for display on the television's display; populating a television menu selection with the legend; upon selection of the menu selection populated with the legend, the television receiver sending the function command to the accessory; and at the accessory device, upon receipt of the function command; running an application at the accessory. This abstract is not to be considered limiting, since other embodiments may deviate from the features described in this abstract.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

When an expansion module is added to an existing system such as a digital television set (DTV) it is generally handled as a completely separate device that will have it's own remote control unit. This is typically done using an independent user interface provided by the new add-on hardware and forces the user to interact with each device separately. The reason this is done is because it is too difficult to design and implement the host device to interact with add-on hardware that has not yet been developed or perhaps even contemplated. There is currently no way to seamlessly add in an add-on module for consumer electronics equipment that is then treated as an integral part of the host device. For existing systems, there is no way to test or debug the host system for a device that does not exist yet.

Additionally, once set up, it is difficult to fully integrate a new accessory device into an operational mode. Currently, accessory devices such as recorders and playback devices are most commonly not integrated and use separate remote controls and each requires that the user enter setup parameters that may be duplicated across devices.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is an exemplary block diagram of a television and accessory device consistent with certain embodiments of the present invention.

FIG. 2 is an exemplary flow diagram of one process consistent with certain embodiments of the present invention.

FIG. 3 is an illustration of an illustrative cross media bar menu having an accessory device function inserted therein consistent with certain embodiments of the present invention.

FIG. 4 is an illustration of the cross media bar after navigation to the accessory device function in a manner consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms including software or firmware functions implementing an “application”, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The term “program”, as used herein, may also be used in a second context (the above definition being for the first context). In the second context, the term is used in the sense of a “television program”. In this context, the term is used to mean any coherent sequence of audio video content which would be interpreted as and reported in an electronic program guide (EPG) as a single television program, without regard for whether the content is a movie, sporting event, segment of a multi-part series, news broadcast, etc.

The term “cursor” as utilized herein is to be interpreted broadly to encompass any mechanism for pointing or highlighting a particular menu selection or other option. In various embodiments, cursors can be in the form of highlighting, foreground coloring, background coloring, bolding, underlining, combinations thereof, or pointing (e.g., arrow or finger cursors) or other mechanisms commonly utilized within menu systems to make a selection.

The term “cross media bar” when used herein is used in reference to a particular type of menu system in which one type of menu attribute is displayed in a horizontal arrangement that crisscrosses other menu selections in a vertical arrangement. The term television receiver or television receiver device as used herein is also to be considered and construed broadly. Such a device contains a menu generating function, and remote control receiver functions and provides an output that is suitable for producing a display. Such device may or may not actually include the display. Thus, for example, a television receiver device may include a television set top box, a television set, or a video recording device that includes a television tuner. Thus, the term television receiver or television receiver device should not be limited to the conventional meaning thereof of a television having a radio frequency receiver that ultimately converts the radio frequency signals into a television display. While certain embodiments depict such television receiver device, the scope of embodiments consistent with the present invention is broader than that. Additionally, although the embodiments discussed utilize a remote commander interface, any suitable user interface for inputting commands is also suitable.

In addition, the term “navigation commands” as used herein is intended to embrace commands that can be utilized to navigate menu systems and carry out any suitable function that can be incorporated within an accessory device consistent with certain embodiments. Examples include up, down, left, right, select, play, stop, fast forward, fast reverse, etc. It will be appreciated by those skilled in the art upon consideration of the present teaching that the term “navigation commands” is taken into context of the functions being carried out on a particular set of hardware and software.

In accordance with certain embodiments, a system such as a digital television (DTV) may have expansion hardware module(s) to allow additional features to be added at a later date. The hardware modules may include their own user interface to allow the user to configure these features. In some cases, the new hardware may duplicate and supersede an element such as an Ethernet connection that already exists on the DTV. In certain embodiments consistent with the present invention, the user interface on the DTV or other television device receives parameters that are specific to the added hardware element and integrates the element into the television's user interface (generally a menu system). Thus, for example, the parameters already available in the DTV set can be utilized by the accessory, and the menu system is integrated into the television set's native menu system.

In accordance with embodiments consistent with the present invention, a mechanism is provided for add-on hardware to acquire the initial setup information from the host device so that the initial setup for the add on module is handled automatically. It provides this capability without requiring that an expensive custom built interface between the devices to serve this need. Certain embodiments use the existing common interfaces between a device such as DTV and an add-on module to pass the setup information from the DTV to the add-on module, and vice versa.

Attachment of the new hardware enables some fundamental handshaking and capability discovery across the communication port upon identification of a module. Certain pertinent information for the exchange of capabilities can be stored in non-volatile memory for sharing.

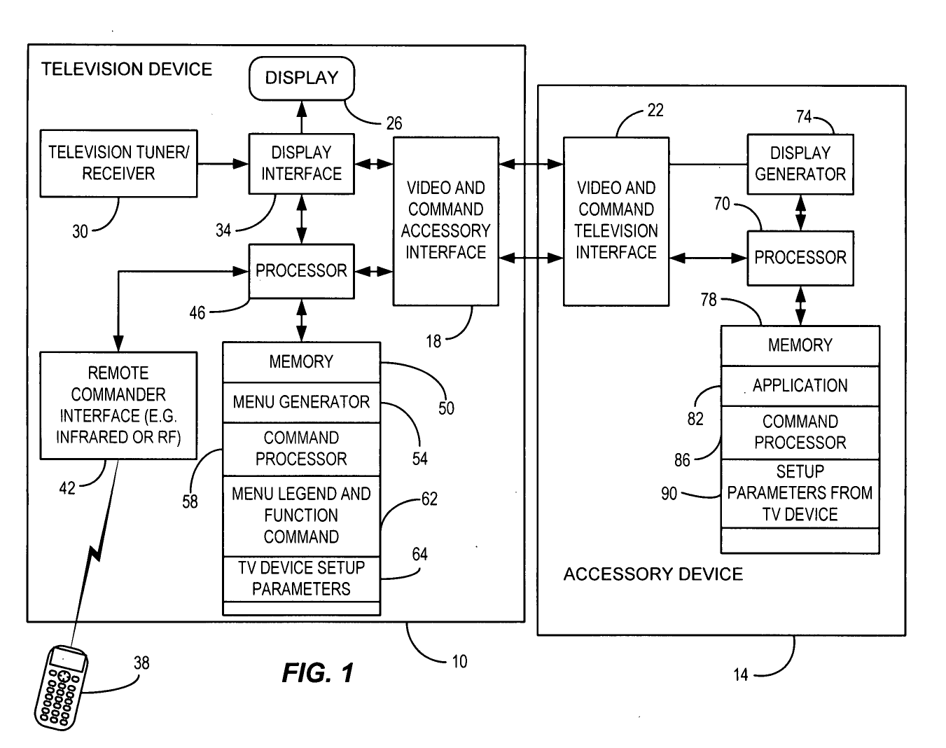

Referring now to FIG. 1, a television device 10 and associated accessory device 14 are depicted. In accordance with embodiments consistent with the present invention, the television device 10 operates utilizing its own state machine and may need no knowledge of the function or operation of the accessory device 14. Similarly, the accessory device operates using its own state machine and may need little or no knowledge of the television device 10. The accessory device 14 may be any associated television device including, for example without intent of limiting, a personal video recorder (PVR), an IPTV (Internet Protocol Television) module, a disc player such as a Blue Ray disc player, or other peripheral device such as devices that permit storage of information on flash memory (e.g., such as a Sony® memory stick®). The television device 10 may be connected to the accessory device 14 utilizing a common interface represented as video and command accessory interface 18 of television 10, which is compatible with video and command television interface 22 of the accessory device 14. By way of example, and not limitation, the interface may incorporate features of one or more of of HDMI, USB, IEEE 1394 and Ethernet. In certain embodiments, such interface may resemble a PCMCIA interface connector capable of carrying video, power and command data. The television device 10 either directly incorporates a display 26 or can be interfaced to a display device 26 as discussed above.

Video signals can be provided to the television tuner/receiver 30 via a cable television system or any other suitable source of video (e.g., recorded media, satellite, etc.). Such video is passed through a display interface 34 (possibly after being converted to a specified format) to display 26 in a conventional manner.

In the embodiment depicted, the various functions of the television device (and the accessory device, as will be discussed later) are controlled via a remote commander 38, such as an infrared remote commander or a radiofrequency remote commander. In other embodiments, other user interface mechanisms including front panel controls and the like may be used. Commands from remote commander 38 are passed to the remote commander interface 42, which interprets the commands and passes information regarding such commands to a processor 46, which may incorporate a hardware based processing system or a software based microcomputer system or the like. In the embodiment depicted, the processor has an associated memory 50 that stores various processes, such as menu generation at 54 and command processing at 58. In the embodiments consistent with the present invention, memory 50 may also incorporate a program that is used to generate menu legends and process function commands from the remote commander at 62. Memory 50 may also include storage of TV device and or accessory device setup parameters and similar data at 64.

It is desirable that the television device essentially operate completely independently of any accessory device that is attached thereto, and thus the accessory device may perform functions that are not yet imagined at the time of manufacture of the television device. Moreover, such functions need not be imagined as they can be carried out in the accessory device 14. Accessory device 14 incorporates a processor such as a microcomputer 70 and a display generator 74 that generates information passed across the interface to display interface 34 for display on the actual display 26. Such displays are used to implement functions of the accessory device. In the embodiment depicted, the accessory device further incorporates a memory 78 that incorporates an application 82 carried out at the accessory device (e.g., storage functions or IPTV functions), along with a command processor 86 that processes commands passed from the television device to the accessory device. Accessory device 14 further may include storage in memory 78 at 90 that stores setup parameters from the television device as well as identifying information about the accessory device and its capabilities. Such information as that stored at 64 and 90 can be exchanged during an initialization process when the accessory device 14 is plugged in or otherwise discovered by the television device 10.

In operation, the television device 10 generates a menu that is displayed via the display interface on display 26. This menu incorporates various functions and sub-functions built into the television device. However, it is desirable that an accessory device coupled to the television device 10 should totally integrate into the television's menu system and therefore be controllable by the same remote commander 38 or other user interface used to navigate the television device's menu. In order to accomplish this, when the accessory device 14 is connected to the television device 10, a handshake operation takes place in which the accessory device passes to the television device a menu legend or icon that is stored in memory 50 at location 62. In addition, the accessory device passes a command (or set of commands) from the accessory 14 to the television device 10 across the interface 18 and 22 that is associated with the menu legend or icon. The menu generator 54 then generates a menu selection showing the menu legend or icon as a part of the television's operational menu. Recall that the television device need not know the function of the accessory device 14. It merely has to display a legend associated with functional operation of the accessory device and know what function command is associated with that menu legend.

Once the menu legend is displayed as part of the television's menu system, if a user selects that menu selection using conventional television menu navigation commands from remote commander 38, the function command associated with that menu legend is passed to the accessory device, and at that point, the accessory device takes control of generating the display presented on display 26 via display generator 74. Once this command is passed to the accessory device 14, the navigation commands from remote commander 38 are simply passed to the accessory device from television 10 without action at the television device 10. The accessory device receives such commands over the interface 18 and 22 and acts upon it in the context of the application 82 being run by the accessory device. Once in this mode, the accessory device essentially takes over receiving commands from the remote commander 38 and carrying out appropriate actions within the context of application 82. Any commands from remote commander 38 that are not relevant to the context are simply ignored.

This action continues until such time as a television menu command is issued at remote commander 38 or other user interface. Once this occurs, the action of the accessory device is halted by receipt of the television menu command and the television device regains control of operation of the display and menu system. Thus, when the television menu command is issued, functional operation of the television device 10 continues in a normal manner and function of the accessory device is halted. Note that in this illustrative embodiment, the only information needed by the television device is information that defines a menu selection legend or icon (e.g., a bitmap image) to be displayed on the television device menu, and a command to pass to the accessory device upon a user selection of such menu selection. The function of the accessory device 14 is irrelevant after that point.

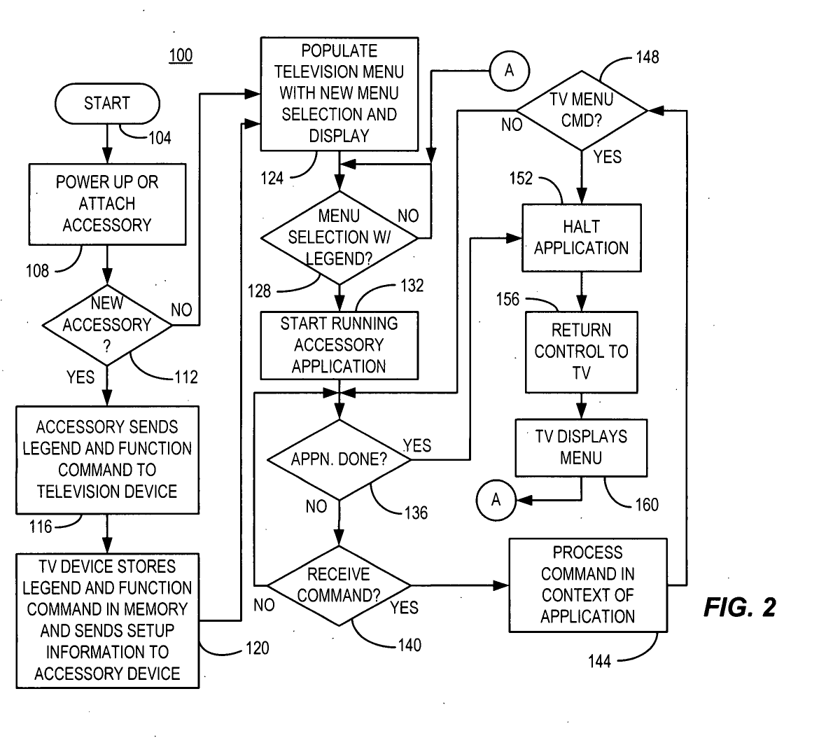

The process just described is depicted in FIG. 2 as process 100 starting at 104. At 108, the system is powered up or the accessory is attached to the television device 10. If this is a new accessory at 112, then the accessory sends a legend (icon) such as a bitmap and a function command to the television device at 116. The television device 10 stores the legend and function command in memory, which is preferably nonvolatile memory, at 120. This may include initial identification of the accessory device such as “Sony xyz” module with, but not limited to, the following capabilities:
Video Codec: Encode/Decode MP-2 MP@HL, MP4 ASP, . . . .
Audio Codec: Encode/Decode AAC, AC-3, . . . .
Cryptographic capabilities: encode/decode AES 128 ECB
Time of Day: . . . .
Time Zone: . . . .
Zip Code: . . . .
IP: . . . .
Gateway: . . . .
Favorites . . . .
language: . . . <e.g. English, French, Spanish, Japanese, Korean, . . . >
UI Theme: . . . <if supported will indicate the “skin” to use for the UI presentation><any other pertinent information>

Thus, the UI allows for automatic, manual, or some combination of set-up options. Additionally at 120, a collection of setup information known to the television device including, but not limited to, time of day; favorites, IP address, model, A/V codec preferences, supported resolutions, current UI theme, etc. is sent from the television device 10 to the accessory device 14.

Once the processes at 120 are completed, control passes to 124 where the television menu is populated with a new menu selection, and the television menu is displayed at 124. In the event at 112 the accessory is not a new accessory (that is the accessory has not been newly attached, but the television has merely been powered up), the legend and function command may already be stored in memory at television device 10, and therefore, the action goes directly to 124 where the television menu is populated.

Once a menu selection has been made that corresponds with the new legend installed in the television menu at 128, the accessory device starts running its application 82 (e.g., IPTV or storage or playback functions) at 132. If the application completes at 136, it halts at 152. Otherwise, it awaits receipts of commands at 140. If a command is received that is meaningful within the context of the application at 140 (e.g., a fast forward command would be meaningful in a playback context, but may not be meaningful in a streaming IPTV environment), then the command is processed in the context of the application at 144. If the command is a television menu command (i.e., the command that pulls up the television device 10's menu system) at 148, then the application halts at 152. Otherwise, control returns to 136 until either the application is completed or another command is received at 140. Once the application is halted at 152, control returns to the television system in a conventional manner at 156, and the television displays a television menu at 160 as before. Control then passes back to 128 to await selection of the menu selection associated with the accessory device.

In accordance with certain embodiments, the menu legend passed from the accessory device 14 to the television device 10 may be in the form of a bit map and identifier or any other suitable mechanism that can be utilized by the television to display an icon or legend within the television's native menu system. In general, operation of the accessory once control has been passed to the accessory, is carried out by navigation through a menu system with conventional remote commander commands, such as left arrow, right arrow, up arrow, down arrow, select function, return function, cancel function, option function, play function, pause function, stop function, and functional characters such as 0-9. The television menu selection function is whatever function is normally utilized to take the television display to a main menu system, in to which the accessory's menu selection is integrated. As previously noted, once that menu selection has been made, the television ignores all commands from the remote commander (or a subset of such commands) and merely passes such commands to the accessory for processing by the accessory. This process remains the case until such time as the television's menu key is again selected to return control to the television.

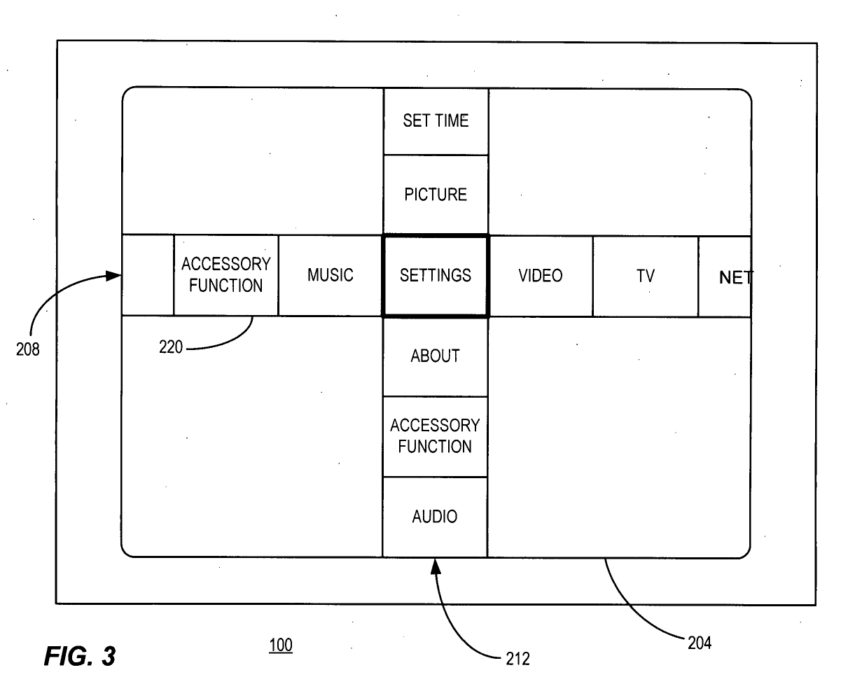

Turning now to FIG. 3, a television display 200 is depicted in which the screen image 204 is one of a cross media bar menu system. The cross media bar menu system is made up of a horizontal bar 208 and a vertical bar 212. Many embodiments of such a menu system can be devised, such as, for example, with the vertical bar 212 representing a series of functions or categories and the horizontal media bar 208 representing a set of subfunctions or subcategories. Or as depicted, the horizontal bar may represent a set of main functions and the vertical bar may represent a set of subfunctions or subcategories. For example, a horizontal bar 208 can represent functions such as tuning to a television channel, and when the intersection of the two bars is channel selection menu selection, the horizontal bar will represent the possible television channel selections that can be made. In another example, the horizontal bar can represent categories of actions such as Music, TV, Settings, video or network functions as shown, or devices to be acted upon. The vertical bar can represent subcategory functions that can be carried out. In accordance with embodiments consistent with the present invention, the menu bar is populated by the menu generator 54 process using processor 46 to generate a slot in the cross media bar menu representing the accessory function depicted here as 220.

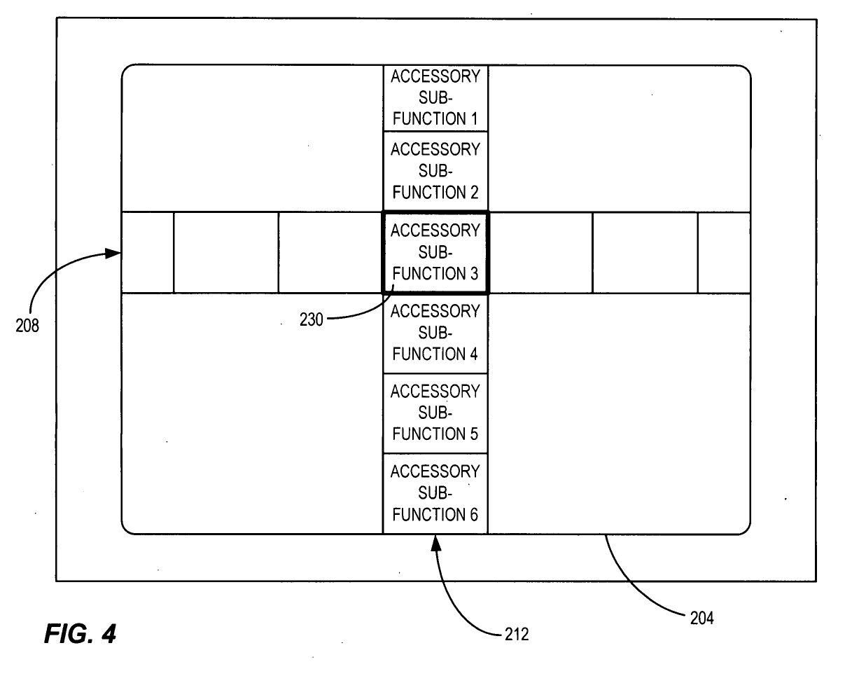

The user can make a selection of the accessory's function 220 in this example by pressing the navigation controls of the remote command 38 to navigate to the accessory function 220. In one embodiment, this takes place by scrolling horizontally so that the accessory function becomes the intersection 230 of the horizontal media bar 208 and the vertical media bar 212 as shown in FIG. 4. When this occurs, the vertical media bar 208 displays sub-functions that can be accessed by scrolling the cursor up or down. In this manner, the accessory's functions can be accessed using conventional remote control functions in a manner that is transparent to the user. Until such time as the accessory's function is accessed using the menu, the television functions in a normal manner. But upon selection of the accessory function, the accessory's function command is passed to the accessory, and control the menu system displayed on the television device is taken over by processor 70, and the menu is displayed using display generator 74, which overwrites or replaces the display produced within the television device 10. It will be clear to those skilled in the art upon consideration of the present teachings that the vertical and horizontal bars can be interchanged, and that embodiments of other menu systems can also be utilized without limitations.

While the present embodiment has been described in terms of a cross media bar menu system, the present invention in various embodiments can be carried out using any conventional or unconventional television menu system. It is also noted that the embodiment discussed utilizes unidirectional command transfer from the television device 10 to the accessory 14. That is, all menu selections are received and processed by the television, and then the accessory is in control, the commands are simply passed to the accessory. In other embodiments, commands can be passed back to the television set if two directional communication is utilized.

In one simple example using two way communication, the menu system displayed by the accessory can also include a main menu selection that is processed by appropriate selection using the remote control's navigation features. When that selection is made, control can be then returned to the television device 10. However, this embodiment is slightly more complex since it uses communication paths from the accessory device to the television device for commands.

Any suitable custom or existing interface can be utilized to provide the interface 18 and 22 between the television device 10 and 14. In one embodiment, a set of connectors that carry HDMI signals plus USB signals plus possibly power can be integrated into a PCMCIA-like module and connector to provide the interface. However, this is not to be considered limiting since other suitable wired or wireless interface arrangements can be devised to provide the communication utilized in conjunction with embodiments consistent with the present invention.

It is also noted that the initial handshaking operation carried out between the television device and the accessory device can either be repeated at each power up of the television device and accessory device or can be carried out upon the power up of the latter of the two devices or can be abbreviated by storage of the legend or icon in nonvolatile memory, along with the associated command within the television device 10. Those skilled in the art will appreciate that numerous variations are possible without departing from embodiments consistent with the present invention

Thus, a method of expansion of a television receiver's functionality consistent with certain embodiments involves connecting an accessory device to the television receiver, wherein the accessory device adds functionality to the television receiver; sending a menu legend and an associated function command to the television receiver from the accessory device for display on the television's display; populating a television menu selection with the legend; upon selection of the menu selection populated with the legend, the television receiver sending the function command to the accessory; and at the accessory device, upon receipt of the function command, running an application at the accessory.

In certain embodiments, the application includes generation of graphics signals that are sent back to the television receiver for display on the television display. In certain embodiments, the method includes while the application is running the television receiver passing navigation commands to the accessory such that the navigation commands navigate menu selections forming a part of the graphics signals, and wherein the television receiver ignores said navigation commands. In certain embodiments, the navigation commands include at least commands that select a menu selection and move a cursor. In certain embodiments, the navigation commands further include recording and playback related commands. In certain embodiments, the method includes upon receipt of a television menu command halting operation of the application.

In certain embodiments, the method includes upon receipt of the television menu command and halting operation of the application the television receiver enters a television menu mode. In certain embodiments, the legend and function command are stored in a non-volatile memory residing in the television receiver In certain embodiments, the accessory device and the television receiver establish a connection whenever the television is powered up, and wherein the legend and function command are retrieved from the non-volatile memory whenever the television receiver is powered up. In certain embodiments, the function command can be a command communicated using one of HDMI, USB, IEEE 1394 and Ethernet. In certain embodiments, the television menu comprises a cross-media bar style menu. In certain embodiments, populating the television menu selection with the legend comprises adding a menu selection to the cross-media bar style menu. In certain embodiments, the method includes at the television receiver, sending a set of stored parameters to the accessory device after the connecting.

Thus, a television accessory device has an interface for connection of the television accessory to a television receiver device. A processor passes a legend and a function command over the interface from the television accessory device to the television receiver device, so that the legend can be installed as a part of a television receiver device's menu, and so that the function command can be passed back to the accessory device over the interface when a user selects a menu selection corresponding to the legend. An application, responsive to the function command received back from the television receiver device over the interface, runs on the television accessory device. A display generator generates graphics to be displayed on a television receiver device's associated display during running of the application.

A television receiver device consistent with certain embodiments has an interface for connecting an accessory device to the television receiver device, wherein the accessory device adds functionality to the television receiver device. A menu display generator displays an operational menu on a display associated with the receiver device. A processor receives a menu legend and an associated function command from the accessory device over the interface for display on the television's display. The processor populates a television menu selection with the legend and associates the function command with the menu selection. A command receiver receives commands from a user, wherein upon selection of the menu selection populated with the legend, the television receiver device sends the function command to the accessory over the interface and passes a subset of user commands to the accessory, ignoring functions of the subset of user commands that would otherwise be carried out by the television receiver device. Upon receiving graphics signals from the accessory device the graphics are displayed on the television display device's associated display.

Those skilled in the art will recognize, upon consideration of the above teachings, that certain of the above exemplary embodiments are based upon use of a programmed processor. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Software and/or firmware embodiments may be implemented using a programmed processor executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies) and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A method of expansion of a television receiver's functionality, comprising:
connecting an accessory device to the television receiver, wherein the accessory device adds functionality to the television receiver;
sending a menu legend and an associated function command to the television receiver from the accessory device for display on the television's display;
populating a television menu selection with the legend;
upon selection of the menu selection populated with the legend, the television receiver sending the function command to the accessory; and
at the accessory device, upon receipt of the function command, running an application at the accessory.

2. The method of expansion of a television functionality according to claim 1, wherein the application includes generation of graphics signals that are sent back to the television receiver for display on the television display.

3. The method of expansion of a television receiver's functionality according to claim 2, wherein while the application is running the television receiver passing navigation commands to the accessory such that the navigation commands navigate menu selections forming a part of the graphics signals, and wherein the television receiver ignores said navigation commands.

4. The method of expansion of a television receiver's functionality according to claim 1, wherein the navigation commands comprise at least commands that select a menu selection and move a cursor.

5. The method of expansion of a television receiver's functionality according to claim 4, wherein the navigation commands further comprise recording and playback related commands.

6. The method of expansion of a television receiver's functionality according to claim 1, wherein upon receipt of a television menu command halting operation of the application.

7. The method of expansion of a television receiver's functionality according to claim 6, wherein upon receipt of the television menu command and halting operation of the application the television receiver enters a television menu mode.

8. The method of expansion of a television receiver's functionality according to claim 1, wherein the legend and function command are stored in a non-volatile memory residing in the television receiver.

9. The method of expansion of a television receiver's functionality according to claim 8, wherein the accessory device and the television receiver establish a connection whenever the television is powered up, and wherein the legend and function command are retrieved from the non-volatile memory whenever the television receiver is powered up.

10. The method of expansion of a television receiver's functionality according to claim 1, wherein the function command comprises a command communicated using one of HDMI, USB, IEEE 1394 and Ethernet.

11. The method of expansion of a television receiver's functionality according to claim 1, wherein the television menu comprises a cross-media bar style menu.

12. The method of expansion of a television receiver's functionality according to claim 11, wherein populating the television menu selection with the legend comprises adding a menu selection to the cross-media bar style menu.

13. The method of expansion of a television receiver's functionality according to claim 1, further comprising at the television receiver, sending a set of stored parameters to the accessory device after the connecting.

14. A computer readable storage medium storing instructions which, when executed on a programmed processor, carry out a process according to claim 1.

15. A television accessory device, comprising:
an interface for connection of the television accessory to a television receiver device;
a processor that passes a legend and a function command over the interface from the television accessory device to the television receiver device, so that the legend can be installed as a part of a television receiver device's menu, and so that the function command can be passed back to the accessory device over the interface when a user selects a menu selection corresponding to the legend;
an application responsive to the function command received back from the television receiver device over the interface that runs on the television accessory device; and
a display generator that generates graphics to be displayed on a television receiver device's associated display during running of the application.

16. The television accessory device according to claim 15, wherein the processor further receives commands passed over the interface from the television receiver device while the application is running, and wherein the commands passed over the interface: while the application is running are interpreted by the processor in the context of the application.

17. The television accessory device according to claim 16, wherein the commands comprise navigation and function selection commands.

18. The television accessory device according to claim 16, wherein while the application is running the navigation commands navigate menu selections forming a part of the graphics generated by the display generator, and wherein the television receiver device ignores said navigation commands.

19. The television accessory device according to claim 16, wherein the navigation commands further comprise recording and playback related commands.

20. The television accessory device according to claim 16, wherein upon receipt of a television menu command operation of the application is halted.

21. The television accessory device according to claim 15, wherein the function command comprises a command communicated using one of HDMI, USB, IEEE 1394 and Ethernet over the interface.

22. The television accessory device according to claim 15, further comprising a memory that stores a set of parameters received from the television device after connection to the accessory device.

23. A television receiver device, comprising:
an interface for connecting an accessory device to the television receiver device, wherein the accessory device adds functionality to the television receiver device;
a menu display generator that displays an operational menu on a display associated with the receiver device;
a processor that receives a menu legend and an associated function command from the accessory device over the interface for display on the television's display;
wherein, the processor populates a television menu selection with the legend and associates the function command with the menu selection;
a command receiver that receives commands from a user, wherein upon selection of the menu selection populated with the legend, the television receiver device sends the function command to the accessory over the interface and passes a subset of user commands to the accessory, ignoring functions of the subset of user commands that would otherwise be carried out by the television receiver device; and
wherein upon receiving graphics signals from the accessory device the graphics are displayed on the television display device's associated display.

24. The television receiver device according to claim 23, wherein the subset of commands comprise navigation commands such that the navigation commands navigate menu selections forming a part of the graphics signals, and wherein the television receiver ignores said navigation commands.

25. The television receiver device according to claim 23, wherein the navigation commands comprise at least commands that select a menu selection and move a cursor.

26. The television receiver device according to claim 23, wherein the navigation commands further comprise recording and playback related commands.

27. The television receiver device according to claim 23, wherein upon receipt of a television menu command the television menu is displayed and the television accessory device halts operation of an application.

28. The television receiver device according to claim 23, wherein the legend and function command are stored in a non-volatile memory within the television receiver device.

29. The television receiver device according to claim 23, wherein the function command comprises a command communicated using one of HDMI, USB, IEEE 1394 and Ethernet over the interface.

30. The television receiver device according to claim 23, wherein the television menu comprises a cross-media bar style menu.

31. The television receiver device according to claim 23, wherein populating the television menu selection with the legend comprises adding a menu selection to the cross-media bar style menu.

32. The television receiver device according to claim 23, further comprising a memory that stores a set of stored parameters that are sent to the accessory device after connection to the accessory device.
